(19) United States
(12) Patent Application Publication
(10) Pub. No.: US 2002/0140653 A1
(43) Pub. Date: Oct. 3, 2002

(54) Image display apparatus and method of supplying common signal

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Shinjuku-ku, Tokyo (JP)

(21) Appl. No.: 10/101,725

(22) Filed: Mar. 21, 2002

(30) Foreign Application Priority Data
Mar. 28, 2001 (JP) 2001-092429
Jan. 25, 2002 (JP) 2002-016513

(51) Int. Cl. G09G 3/36

(52) U.S. Cl. 345/87

(57) ABSTRACT

An image display apparatus using a liquid crystal device having multiple pixels has a signal generation circuit that generates a signal having a signal level varying with elapse of time, as a common signal to be commonly given to the multiple pixels. This arrangement effectively prevents screen burn on the liquid crystal device in the image display apparatus.

### BACKGROUND OF THE INVENTION

1. Field of the Invention

The present invention relates to a technique of preventing screen burn in an image display apparatus using a liquid crystal device.

2. Description of the Related Art

Liquid crystal devices have widely been used as an electro-optical device for generating images. The liquid crystal device applies a voltage to each of pixels constituting liquid crystal in response to a pixel signal corresponding to each pixel and regulates the permeability of light emitted to irradiate each pixel, thus creating an image.

FIGS. 8A and 8B show a problem arising in a prior art image display apparatus using a liquid crystal device. The procedure tries to display a homogeneous gray image over the whole screen after a long-time display of a black and white checker pattern image as shown in FIG. 8(A). In this case, although the homogeneous gray image is expected be displayed over the whole screen, the trace of the previous display may remain in the white display portion or in the black display portion as shown in FIG. 8(B). This is screen burn. In the example of FIG. 8(B), the trace of the previous display remains as darker areas in the white display portion.

Such screen burn becomes more significant with a reduction in size of the image display apparatus and with an increase in luminance or resolution of the displayed image.

### SUMMARY OF THE INVENTION

The object of the present invention is thus to provide a technique of preventing screen burn in an image display apparatus using a liquid crystal panel.

At least part of the above and the other related objects is attained by a technique that generates a signal having a signal level varying with elapse of time, as a common signal to be commonly given to multiple pixels on a liquid crystal device and supplies the common signal to the liquid crystal device.

The variation in common signal, which is commonly given to the multiple pixels, with elapse of time effectively prevents screen burn.

It is preferable that the variation in common signal has a period that is sufficiently greater than a 1-frame scanning period, in which an image of 1 frame is generated on the liquid crystal device.

It is especially preferable that the period of the variation in common signal has a length of not less than 600 times the 1-frame scanning period.

The setting of a sufficiently greater period than the 1-frame scanning period, especially a period of not less than 600 times the 1-frame scanning period, to the period of the variation in common signal effectively prevents the adverse effects of the time-based variation in common signal on the picture quality, for example, flicker.

It is also preferable that the variation in common signal has an amplitude in a range of ±1 mV to ±100 mV about a preset signal level.

This arrangement effectively prevents the adverse effects of the variation in level of the common signal on the picture quality.

The technique of the present invention is attained by a diversity of applications including an image display apparatus, a method of displaying an image, and a method of supplying a common signal.

### BRIEF DESCRIPTION OF THE DRAWINGS

FIG. 1A and 1B show an equivalent circuit to an arbitrary pixel in a liquid crystal panel used as a display device and a variation in voltage applied to the arbitrary pixel;

FIG. 2 is a block diagram schematically illustrating the structure of an image display apparatus in one embodiment of the present invention;

FIG. 3 shows the waveform of a counter electrode voltage Vcom generated by an LCCOM generation circuit 130;

FIG. 4 shows a voltage waveform added to the counter electrode voltage Vcom to check burn-in prevention effect;

FIG. 5 shows a method of checking the burn-in prevention effect;

FIG. 6 shows an example of checking the burn-in prevention effect when the voltage waveform shown in FIG. 4 is added to the counter electrode voltage Vcom;

FIG. 7A and 7B show the construction of another LCCOM generation circuit 130a as a modified example; and

FIG. 8A and 8B show a problem arising in a prior art image display apparatus using a liquid crystal panel.

### DESCRIPTION OF THE PREFERRED EMBODIMENTS

One mode of carrying out the present invention is discussed below as a preferred embodiment in the following sequence:

A. Cause of Burn-in

B. Construction of Image Display Apparatus

C. Burn-in Prevention Effect

D. Modifications

A. Cause of Burn-in

The screen burn discussed in the prior art is ascribed to the cause discussed below.

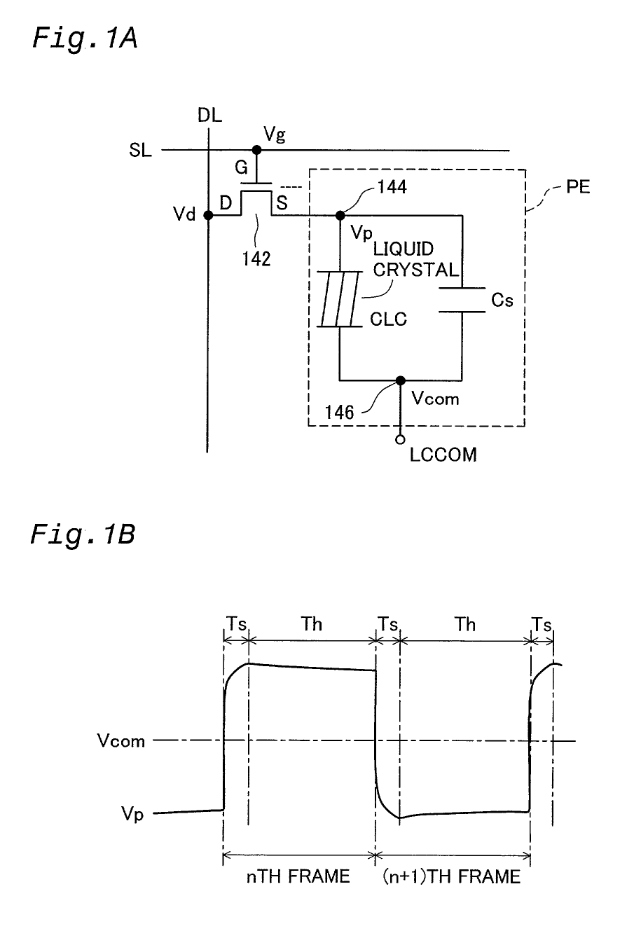

FIGS. 1A and 1B show an equivalent circuit to an arbitrary pixel in a liquid crystal panel (liquid crystal device) and the waveform of a voltage applied to the arbitrary pixel. As shown in FIG. 1(A), one pixel PE is provided on an intersection of a scanning line SL and a signal line DL perpendicular to each other via a TFT (thin film transistor) 142 as a switching element. The TFT (hereinafter referred to as the ‘TFT switch’) 142 has a gate electrode connecting with the scanning line SL, a drain electrode connecting with the signal line DL, and a source electrode connecting with a pixel electrode 144 of the pixel PE. A counter electrode 146 facing the pixel electrode 144 is connected to a counter electrode signal line LCCOM. The counter electrode 146 is generally constructed as a common electrode to all pixels. From this viewpoint, the counter electrode signal line is also called the common electrode signal line. In the following discussion, the same symbol LCCOM is allocated to both the counter electrode signal line and the counter electrode signal.

Liquid crystal is interposed between the pixel electrode 144 and the counter electrode 146. The liquid crystal is equivalently regarded as a volume CLC (hereinafter referred to as the ‘liquid crystal volume’). An accumulated volume Cs is added in parallel to the liquid crystal volume CLC. A resultant volume Cpe of the liquid crystal volume CLC and the accumulated volume Cs (Cpe=CLC·Cs/(CLC+Cs)) is referred to as the ‘pixel volume’.

A pixel signal voltage Vd corresponding to the pixel PE, out of a display signal Vsig supplied through the signal line DL, is written into the pixel volume Cpe via the TFT switch 142, which is controlled on and off in response to a switch voltage Vg of a scanning line driving signal supplied through the scanning line SL. More concretely, the pixel signal voltage Vd is written into the pixel volume Cpe as a pixel electrode voltage Vp during a sampling period Ts, and the pixel electrode voltage Vp is kept for a hold period Th as shown in FIG. 1(B). The potential difference between the pixel electrode voltage Vp supplied to the pixel electrode 144 and a counter electrode voltage Vcom supplied to the counter electrode 146 actuates the liquid crystal on the pixel electrode 144. Such actuation occurs in a plurality of other pixels arranged in a matrix.

When a direct current (DC) voltage is applied to the liquid crystal for a long time period, the physical properties of the material vary in the liquid crystal, for example, due to the occurrence of polarization by impurity ions. This decreases the resistance factor and results in deteriorating phenomena. One example of the deteriorating phenomena is screen burn.

In order to solve this problem, the prior art technique adopts alternating-current actuation of each pixel. As shown in FIG. 1(B), the procedure inverts the pixel electrode voltage Vp applied to the pixel electrode 144 relative to the counter electrode voltage Vcom applied to the counter electrode 146 at every frame scanning period and thereby makes a mean, voltage of 0 applied between the pixel electrode 144 and the counter electrode 146. The mean voltage of 0 attains actuation without application of the DC voltage (DC offset) to the liquid crystal.

The alternating current actuation that makes the mean voltage of 0 applied to each pixel PE is not actualized, because of the following reason.

The optimum value of the counter electrode voltage Vcom that makes the mean value of 0 applied to each pixel PE depends upon the magnitude of the pixel electrode voltage Vp applied to the pixel electrode 144, that is, upon the tone level of the pixel signal. This phenomenon becomes more remarkable with an increase in resolution of the liquid crystal panel, that is, with a decrease in pixel volume Cpe due to the increasing number of pixels and the reduced size of the liquid crystal panel.

Even if the counter electrode voltage Vcom is set to have the optimum value in black display, the setting of the counter electrode voltage Vcom is deviated from the optimum value in white display. The mean voltage applied to pixels in white display is accordingly not equal to zero, but the DC offset is effectively applied. This causes burn of an image as described in the prior art. The same problem arises when the counter electrode voltage Vcom is set to have the optimum value in white display or intermediate tone display, instead of black display.

B. Construction of Image Display Apparatus

By taking into account the reason of screen burn discussed above, an image display apparatus of an embodiment has the construction discussed below to prevent screen burn.

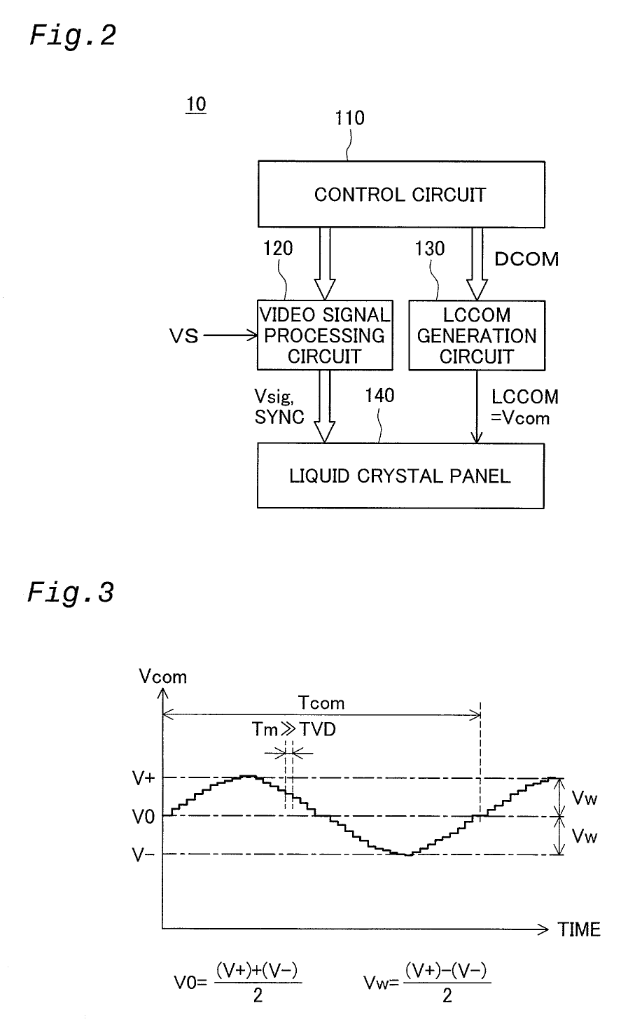

FIG. 2 is a block diagram schematically illustrating the construction of an image display apparatus 10 in one embodiment of the present invention. The image display apparatus 10 includes a control circuit 110, a video signal processing circuit 120, a counter electrode signal (LCCOM) generation circuit 130, and a liquid crystal panel 140. The image display apparatus 10 has a lighting optical system (not shown) for illuminating the liquid crystal panel 140.

The control circuit 110 controls operations of the video signal processing circuit 120 and the LCCOM generation circuit 130, as well as the whole image display apparatus 10.

The video signal processing circuit 120 generates a timing signal SYNC that controls the operations of the liquid crystal panel 140, and converts an input video signal VS into a display signal Vsig transmittable to the liquid crystal panel 140 synchronously with the timing signal SYNC. The timing signal SYNC includes a vertical synchronizing signal VD, a horizontal synchronizing signal HD, and a clock signal CLK.

The LCCOM generation circuit 130 includes a D-A converter or an electronic volume and generates the counter electrode voltage Vcom, which is supplied to the counter electrode 146 (see FIG. 1) of each pixel PE through the counter electrode signal line LCCOM of the liquid crystal panel 140, based on control data DCOM output from the control circuit 110.

FIG. 3 shows the waveform of the counter electrode voltage Vcom generated by the LCCOM generation circuit 130. As shown in FIG. 3, the LCCOM generation circuit 130 generates a periodic signal, which varies at every unit time Tm and repeats the series of variation in every period Tcom (≧2·Tm). The unit time Tm is set to be sufficiently greater than the period of the vertical synchronizing signal VD, that is, a frame scanning period TVD. For example, the setting is Tm≧600·TVD. A central voltage V0 is set to be a central value (=((V+)+(V−))/2) of a maximum value (V+) and a minimum value (V−) among the optimum values of the counter electrode voltage Vcom respectively corresponding to multiple tone levels of the display signal Vsig input into the liquid crystal panel 140. An amplitude Vw is set to be half the difference between the maximum value (V+) and the minimum value (V−). The width (range) of the variation in optimum value of the counter electrode voltage Vcom is typically about 2 mV to 200 mV. The amplitude Vw ranges about 1 mV to 100 mV. The amplitude Vw is generally set to about 20 mV through 30 mV. The variation in amplitude per unit time Tm is typically set to about 5 mV through 10 mV.

The liquid crystal panel 140 shown in FIG. 2 displays an image in response to the display signal Vsig and the timing signal SYNC output from the video signal processing circuit 120 and the counter electrode signal LCCOM output from the LCCOM generation circuit 130.

FIG. 2 regards the direct-view image display apparatus that gives direct sight of the image generated on the liquid crystal panel 140. The technique of the present invention is also applicable to a projection-type display apparatus (projector) having a projection optical system for projecting the image generated on the liquid crystal panel 140.

In the image display apparatus 10 of this embodiment, the value of the counter electrode voltage Vcom is periodically varied as described above. For example, while a positive DC offset is effectively applied in a certain time period, the positive DC offset is suppressed but a negative DC offset is applied in another time period. On the contrary, while a negative DC offset is effectively applied in a certain time period, the negative DC offset is suppressed but a positive DC offset is applied in another time period. This effectively reduces the long-time application of the DC offset to each pixel on the liquid crystal panel 140, thus preventing screen burn caused by the DC offset.

The variation in counter electrode voltage Vcom leads to a variation in luminance of display. Setting a short time period to the unit time Tm of the variation undesirably affects the human vision. In the arrangement of the embodiment, the setting is Tm≧600·TVD. The unit time Tm of the variation is sufficiently longer than the frame scanning period TVD. It is thus practically unnecessary to take into account the effect of the variation in luminance of display due to the variation in counter electrode voltage Vcom.

A significantly large amplitude Vw of the counter electrode voltage Vcom also leads to a variation in luminance of display. While the pixel electrode voltage Vp is generally in the range of several to 10 V, the width (range) of the variation in optimum value of the counter electrode voltage Vcom is about 2 mV to 200 mV. Namely the amplitude Vw ranges about 1 mV to 100 mV. It is thus practically unnecessary to take into account the effect due to the variation in counter electrode voltage Vcom.

C. Burn-in Prevention Effect

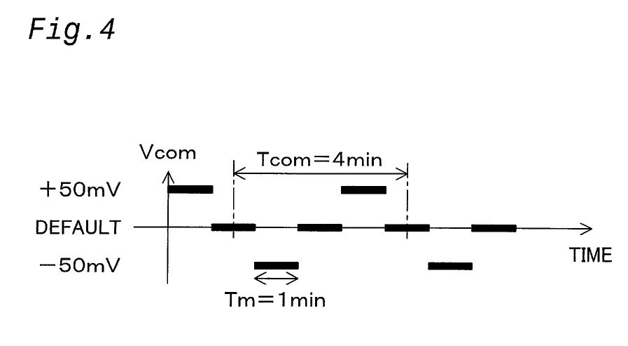

An example of checking burn-in prevention effect is described below. FIG. 4 shows a voltage waveform added to the counter electrode voltage Vcom to check the burn-in prevention effect. As shown in FIG. 4, the voltage waveform added to the counter electrode voltage Vcom is a periodic signal that varies as a default voltage, +50 mV, the default voltage, −50 mV at every 1 minute interval (unit time Tm) and repeats the series of variation in every 4 minute period (period Tcom).

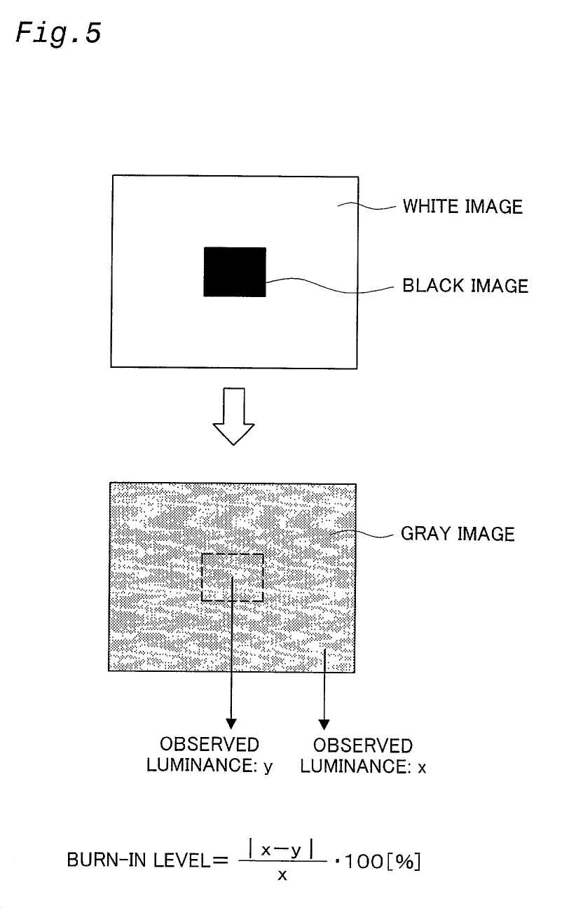

FIG. 5 shows a method of checking the burn-in prevention effect. The procedure first displays a white solid image and a black solid image for a fixed time period (hereinafter referred to as the ‘burn-in time’) as shown in the upper half of FIG. 5, and then displays a gray solid image as shown by the lower half of FIG. 5. The procedure measures a luminance x at the position of the display of the white solid image and a luminance y at the position of the display of the black solid image. The procedure then calculates the ratio of the absolute difference between the luminance x and the luminance y to the luminance x from the observed luminances x and y as a burn-in level according to an equation given below:

Burn-in level=100·|x−y|/x

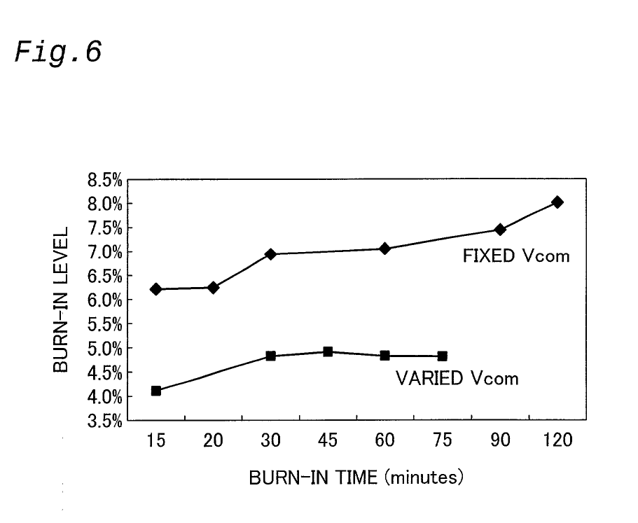

FIG. 6 shows an example of checking the burn-in prevention effect when the voltage waveform shown in FIG. 4 is added to the counter electrode voltage Vcom. The measurement result of FIG. 6 shows that addition of the voltage waveform improves the burn-in level by at least 2%. The greater burn-in prevention effect is attained with an increase in burn-in time.

D. Modifications

The present invention is not restricted to the above embodiment or its application, but there may be many modifications, changes, and alterations without departing from the scope or spirit of the main characteristics of the present invention. All changes within the meaning and range of equivalency of the claims are therefore intended to be embraced therein. Some examples of possible modification are given below.

D1. Modified Example 1

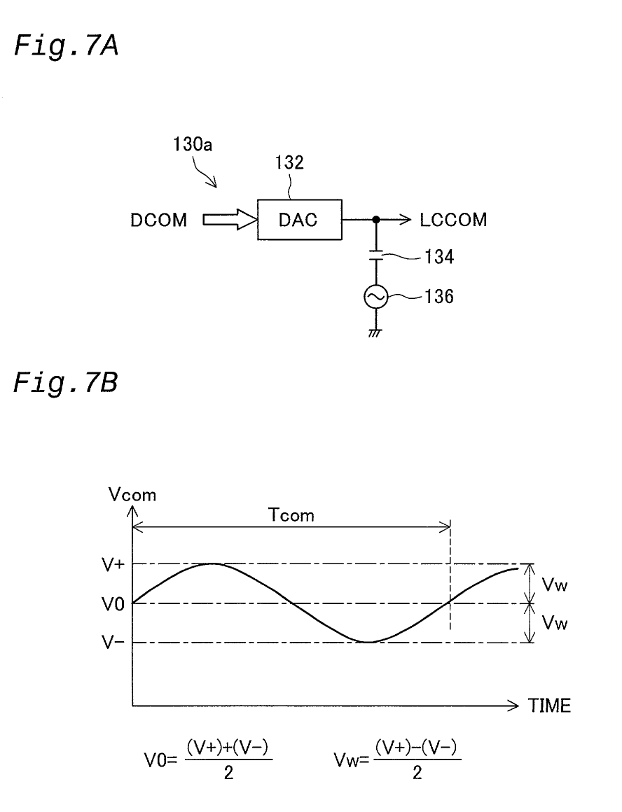

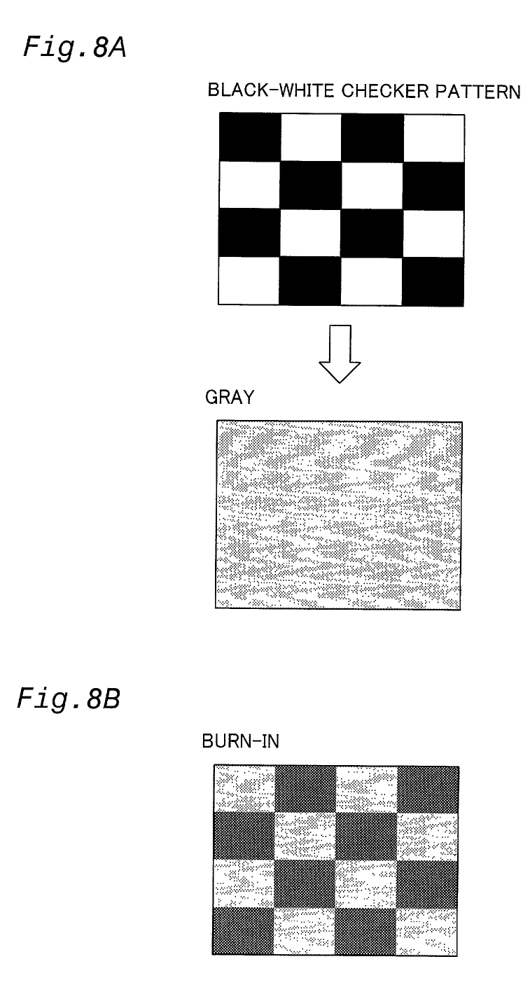

The LCCOM 130 of the above embodiment is constructed to vary the control signal DCOM supplied from the control signal 110, thus varying the value of the counter electrode voltage Vcom supplied to the counter electrode signal line LCCOM. The LCCOM is not restricted to this construction. FIGS. 7A and 7B show the construction of another LCCOM generation circuit 130a as a modified example. The LCCOM generation circuit 130a has a D-A converter (DAC) 132 and an oscillation circuit 136 as shown in FIG. 7(A). Output of the oscillation circuit 136 is connected to output of the DAC 132 via a coupling capacitor 134.

This LCCOM generation circuit 130a generates a central voltage V0, which is the center of the variation in counter electrode voltage Vcom, in response to the control signal DCOM supplied from the control circuit 110. The oscillation circuit 136 outputs a periodic signal having the period Tcom and an amplitude that is half the difference between the maximum value V+ and the minimum value V− out of the optimum values of the counter electrode voltage Vcom. The LCCOM generation circuit 130a accordingly outputs a periodic signal having the period Tcom and an amplitude Vw(=((V+)−(V−))/2) about the voltage value V0(=((V+)+(V−))/2) as shown in FIG. 7(B), as the counter electrode voltage Vcom supplied through the counter electrode signal line LCCOM.

The LCCOM generation circuit 130a exerts the same effects as those of the LCCOM generation circuit 130 in the above embodiment. The LCCOM generation circuit 130a varies the counter electrode voltage Vcom unsynchronously with the control signal DCOM supplied from the control circuit 110.

D2. Modified Example 2

The variations in counter electrode voltage Vcom in the LCCOM generation circuit 130 of the embodiment and in the LCCOM generation circuit 130a of the modified example are only illustrative and not restrictive in any sense. For example, the LCCOM generation circuit 130 or the LCCOM generation circuit 130a outputs the periodic signal having a monotonous increase or monotonous decrease in counter electrode voltage Vcom. The periodic signal may otherwise have a discrete increase or discrete decrease in counter electrode voltage Vcom. The periodic signal has the amplitude that is half the difference between the maximum value (V+) and the minimum value (V−) out of the optimum values of the counter electrode voltage Vcom corresponding to multiple tone levels of the supplied display signal. The periodic signal may otherwise have an amplitude greater than or smaller than half the difference. The counter electrode voltage Vcom supplied to the counter electrode voltage signal line LCCOM may thus be varied arbitrarily, as long as the variation has the effect of preventing burn-in of an image displayed on the liquid crystal panel 140.

The scope and spirit of the present invention are indicated by the appended claims, rather than by the foregoing description.

What is claimed is:

1. An image display apparatus using a liquid crystal device having multiple pixels, the image display apparatus comprising:
a signal generation circuit that generates a signal having a signal level varying with elapse of time, as a common signal to be commonly given to the multiple pixels.

2. An image display apparatus in accordance with claim 1, wherein the variation in common signal has a period that is sufficiently greater than a 1-frame scanning period, in which an image of 1 frame is generated on the liquid crystal device.

3. An image display apparatus in accordance with claim 2, wherein the period of the variation in common signal has a length of not less than 600 times the 1-frame scanning period.

4. An image display apparatus in accordance with claim 3, wherein the variation in common signal has an amplitude in a range of ±1 mV to ±100 mV about a preset signal level.

5. An image display apparatus in accordance with claim 1, wherein the variation in common signal has an amplitude in a range of ±1 mV to ±100 mV about a preset signal level.

6. An image display apparatus in accordance with claim 2, wherein the variation in common signal has an amplitude in a range of ±1 mV to ±100 mV about a preset signal level.

7. A method of supplying a common signal to a liquid crystal device, the common signal being to be commonly given to multiple pixels on the liquid crystal device, the method comprising the step of:
generating a signal having a signal level varying with elapse of time, as the common signal to be commonly given to the multiple pixels, and supplying the common signal to the liquid crystal device.

8. A method in accordance with claim 7, wherein the variation in common signal has a period that is sufficiently greater than a 1-frame scanning period, in which an image of 1 frame is generated on the liquid crystal device.

9. A method in accordance with claim 8, wherein the period of the variation in common signal has a length of not less than 600 times the 1-frame scanning period.

10. A method in accordance with claim 9, wherein the variation in common signal has an amplitude in a range of ±1 mV to ±100 mV about a preset signal level.

11. A method in accordance with claim 7, wherein the variation in common signal has an amplitude in a range of ±1 mV to ±100 mV about a preset signal level.

12. A method in accordance with claim 8, wherein the variation in common signal has an amplitude in a range of ±1 mV to ±100 mV about a preset signal level.
